(19) United States
(12) Patent Application Publication
(10) Pub. No.: US 2025/0085411 A1
(43) Pub. Date: Mar. 13, 2025

(54) VERTICAL LOCALIZATION BETWEEN DEVICES USING ALTITUDE MEASUREMENTS

(71) Applicant: APPLE INC., CUPERTINO, CA (US)

(72) Inventors: Gabrielle A. Belzberg, San Francisco, CA (US); Alexander J. Wiens, Campbell, CA (US); Halil I. Basturk, San Jose, CA (US); Stephen Jackson, San Jose, CA (US)

(73) Assignee: APPLE INC., CUPERTINO, CA (US)

(21) Appl. No.: 18/796,144

(22) Filed: Aug. 6, 2024

Related U.S. Application Data
(60) Provisional application No. 63/537,780, filed on Sep. 11, 2023.

(51) Int. Cl. G01S 13/76

(52) U.S. Cl. CPC G01S 13/76

(57) ABSTRACT

In some implementations, the techniques may include at a first time: performing, using a first sensor, a first ranging measurement with a second device to obtain a first distance; and performing, using a second sensor, a first altitude measurement to obtain a first altitude. In addition, the techniques may include at a second time: performing, using the first sensor, a second ranging measurement with the second device to obtain a second distance; and performing, using the second sensor, a second altitude measurement to obtain a second altitude. The techniques may include determining a ranging difference between the first distance and the second distance. Moreover, the techniques may include determining an altitude difference between the first altitude and the second altitude. Also, the techniques may include determining whether the second device is on a different floor of a building than the first device.

### CROSS-REFERENCES TO OTHER APPLICATIONS

This application claims priority to U.S. Provisional Application No. 63/537,780, for “Vertical Localization Between Devices Using Altitude Measurements” filed on Sep. 11, 2023, which is herein incorporated by reference in its entirety for all purposes.

### BACKGROUND

Localization techniques may struggle to locate a target device in a multistory building. Without a means to determine altitude, a tracking device may not be able to distinguish whether the target device is on the same floor or a different floor in the building. Air pressure readings can be used to determine altitude; however, a tracking device may struggle to calculate an absolute altitude measurement (e.g., 1,000 feet above sea level) because altitude readings can vary significantly due to climatic conditions. Accordingly, improvements to localization techniques are desirable.

### BRIEF SUMMARY

In one general aspect, techniques may include at a first time: performing, using a first sensor, a first ranging measurement with a second device to obtain a first distance; and performing, using a second sensor, a first altitude measurement to obtain a first altitude. Method may also include at a second time: performing, using the first sensor, a second ranging measurement with the second device to obtain a second distance; and performing, using the second sensor, a second altitude measurement to obtain a second altitude. The techniques may furthermore include determining a ranging difference between the first distance and the second distance. The techniques may in addition include determining an altitude difference between the first altitude and the second altitude. The techniques may moreover include determining whether the second device is on a different floor of a building than the first device. Other embodiments of these techniques may include corresponding methods, computer systems, apparatus, and computer programs recorded on one or more computer storage devices, each configured to perform the actions of the techniques.

Implementations may include one or more of the following features. The techniques may include: displaying a notification on a display of the first device, the notification indicating that the second device is on the different floor of the building than the first device. The techniques may include: at the first time: displaying a first notification on a display of the first device, the first notification instructing an user of the first device to hold the first device at the first altitude; and at the second time: displaying a second notification on the display of the first device, the second notification instructing the user of the first device to change the distance between the first device and a ceiling of the building.

Other embodiments are directed to systems, portable consumer devices, and computer readable media associated with techniques described herein. A better understanding of the nature and advantages of embodiments of the present disclosure may be gained with reference to the following detailed description and the accompanying drawings.

### BRIEF DESCRIPTION OF THE DRAWINGS

FIG. 1 shows a sequence diagram for performing a ranging measurement between two mobile devices according to embodiments of the present disclosure.

FIG. 2 show a simplified diagram showing how increasing altitude can be used to determine that the target mobile device is above the tracking mobile device according to various embodiments.

FIG. 3 show a simplified diagram showing how decreasing altitude can be used to determine that the target mobile device is below the tracking mobile device according to various embodiments.

FIG. 4 show a simplified diagram showing how increasing altitude can be used to determine that the target mobile device is below the tracking mobile device according to various embodiments.

FIG. 5 show a simplified diagram showing how decreasing altitude can be used to determine that the target mobile device is below the tracking mobile device according to various embodiments.

FIG. 6 show a simplified diagram showing how increasing altitude can be used to determine that the target mobile device is approximately at the same altitude as the tracking mobile device according to various embodiments.

FIG. 7 show a simplified diagram showing how decreasing altitude can be used to determine that the target mobile device is approximately at the same altitude as the tracking mobile device according to various embodiments.

FIG. 8 is a simplified flowchart of a technique for determining the vertical position of a target mobile device using altitude measurements from a single device according to at least one embodiment.

FIG. 9 shows a simplified diagram showing a tracking mobile device determining the altitude of a target mobile device using altitude measurements from two devices according to at least one embodiment.

FIG. 10 is a simplified flowchart of a technique for determining the vertical position of a target mobile device using altitude measurements from multiple devices according to at least one embodiment.

FIG. 11 is a block diagram of components of a mobile device operable to perform ranging according to embodiments of the present disclosure.

FIG. 12 is a block diagram of an example device, which may be a mobile device.

### DETAILED DESCRIPTION

Users may employ a variety of mobile devices to perform various functions. For example, a user may browse the internet with a tablet computer, track their fitness with a smartwatch, and text with a smartphone. Keeping track of these devices can be frustrating and time consuming, but one of these devices can be used to locate one or more of the other devices. For example, a first mobile device (e.g., the tracking mobile device) can be used to locate a second mobile device (e.g., the findee or the target mobile device).

The tracking mobile device can calculate a distance between the tracking mobile device and the target mobile device by exchanging ranging messages with the tracked device. The time that each message takes to travel between the devices, and the signal strength of each received message, can be used to determine this distance, and, through repeated distance measurements, a user of the tracking mobile device can determine their distance relative to the target mobile device. As the user moves around the search space, the calculated distance can be used to inform the user's movement so that the user minimizes the distance from the tracked device (e.g., as in the children's game “Hot & Cold”).

One dimensional distance calculations may not be sufficient to locate a device in a multistory search space. A user searching on a floor of the multistory search space may reach a local minimum where the distance between the tracking mobile device and the target mobile device cannot be reduced further without changing floors. In such cases, the user may not be able to determine which floor to search next without changing floors which can be time consuming and degrade the customer experience. Additionally, the extended search can consume battery life and increases the possibility that one or more of the devices loses power during the search.

Whether a target mobile device is above or below the tracking mobile device can be determined by measuring the air pressure at the tracking device. In general, air pressure decreases with altitude, and, over short timescales, the device's air pressure readings can be used to determine if the direction of changes in the tracking device's altitude. For example, the air pressure of the tracking mobile device can decrease as the tracking mobile device moves upwards and the pressure can increase as the device moves downwards. These pressure changes can be detected over short distances, and, for example, the tracking mobile device can detect that the user holding the target mobile device has gotten up from a seated position.

The direction of altitude change can be used, in conjunction with distance measurements, to determine if the target mobile device is above or below the tracking mobile device. When a change in altitude is detected, the distance between the devices can be measured at each altitude. The direction of the change in altitude can be compared against the net change in distance. For example, if the tracking device increases in altitude and the distance decreases then the target mobile device may be on a floor that is above the tracking mobile device's current floor. If the tracking device's altitude increases and the distance increases, then the target mobile device may be below the tracking mobile device.

### I. Ranging

In some embodiments, a mobile device can include circuitry for performing ranging measurements. Such circuitry can include one or more dedicated antennas (e.g., 3) and circuitry for processing measured signals. The ranging measurements can be performed using the time-of-flight of pulses between the two mobile devices. In some implementations, a round-trip time (RTT) is used to determine distance information, e.g., for each of the antennas. In other implementations, a single-trip time in one direction can be used. The pulses may be formed using ultra-wideband (UWB) radio technology.

### A. Sequence Diagram

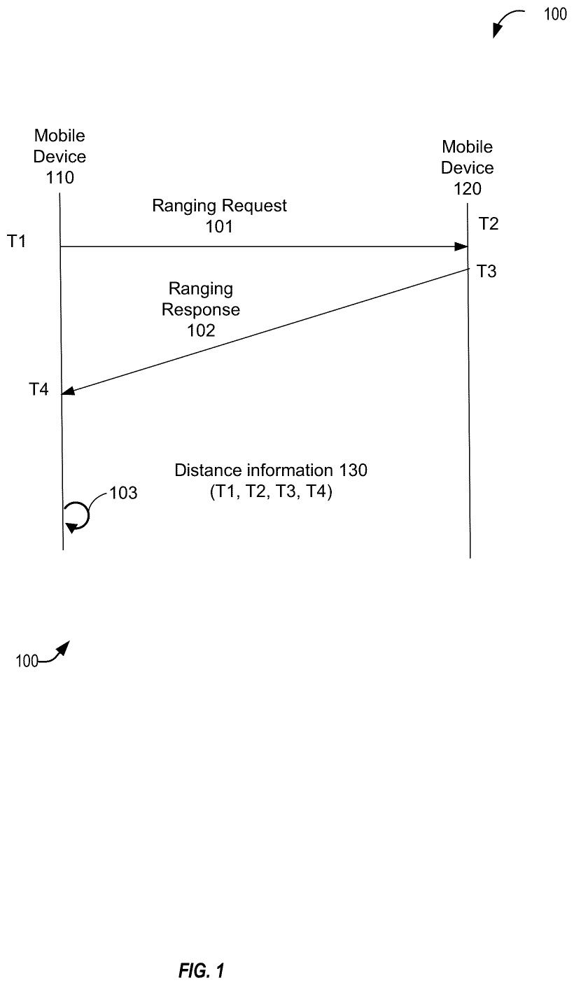

FIG. 1 shows a sequence diagram 100 for performing a ranging measurement between two mobile devices according to embodiments of the present disclosure. The two mobile devices may belong to two different users. The two users may know each other, and thus have each other's phone numbers or other identifiers. As described in more detail later, such an identifier can be used for authentication purposes, e.g., so ranging is not performed with unknown devices. Although FIG. 1 shows a single measurement, the process can be repeated to perform multiple measurements over a time interval as part of a ranging session, where such measurements can be averaged or otherwise analyzed to provide a single distance value, e.g., for each antenna.

A first mobile device 110 (e.g., a smartphone) can initiate a ranging measurement (operation) by transmitting a ranging request 101 to a second mobile device 120. Ranging request 101 can include a first set of one or more pulses. The ranging measurement can be performed using a ranging wireless protocol (e.g., UWB). The ranging measurement may be triggered in various ways, e.g., based on user input and/or authentication using another wireless protocol, e.g., Bluetooth low energy (BLE).

At T₁, the first mobile device 110 transmits ranging request 101. At T₂, the second mobile device 120 receives ranging request 101. T₂ can be an average received time when multiple pulses are in the first set. The second mobile device 120 can be expecting the ranging request 101 within a time window based on previous communications, e.g., using another wireless protocol. The ranging wireless protocol and another wireless protocol can be synchronized so that mobile device 120 can turn on the ranging antenna(s) and associated circuitry for a specified time window, as opposed to leaving them on for an entire ranging session.

In response to receiving the ranging request 101, mobile device 120 can transmit ranging response 102. As shown, ranging response 102 is transmitted at time T₃, e.g., a transmitted time of a pulse or an average transmission time for a set of pulses. T₂ and T₃ may also be a set of times for respective pulses. Ranging response 102 can include times T₂ and T₃ so that mobile device 110 can compute distance information. As an alternative, a delta between the two times (e.g., T₃−T₂) can be sent. The ranging response 102 can also include an identifier for the first mobile device 110, an identifier for the second mobile device 120, or both.

At T₄, the first mobile device 110 can receive ranging response 102. Like the other times, T₄ can be a single time value or a set of time values.

At 103, the first mobile device 110 computes distance information 130, which can have various units, such as distance units (e.g., meters) or as a time (e.g., milliseconds). Time can be equivalent to a distance with a proportionality factor corresponding to the speed of light. In some embodiments, a distance can be computed from a total round-trip time, which may equal T₂−T₁+T₄−T₃. In some embodiments, the processing time for the second mobile device 120 can also be subtracted from the total round-trip time. More complex calculations can also be used, e.g., when the times correspond to sets of times for sets of pulses and when a frequency correction is implemented.

### B. UWB

The wireless protocol used for ranging can have a narrower pulse (e.g., a narrower full width at half maximum (FWHM)) than a first wireless protocol (e.g., Bluetooth) used for initial authentication or communication of ranging settings. In some implementations, the ranging wireless protocol (e.g., UWB) can provide distance accuracy of 5 cm or better. In various embodiments, the frequency range can be between 3.1 to 10.6 Gigahertz (GHz). Multiple channels can be used, e.g., one channel at 6.5 GHz another channel at 8 GHz. Thus, in some instances, the ranging wireless protocol does not overlap with the frequency range of the first wireless protocol (e.g., 2.4 to 2.485 GHz).

The ranging wireless protocol can be specified by IEEE 802.15.4, which is a type of UWB. Each pulse in a pulse based UWB system can occupy the entire UWB bandwidth (e.g., 500 MHz), thereby allowing the pulse to be localized in time (i.e., narrow width in time, e.g., 0.5 ns to a few nanoseconds). In terms of distance, pulses can be less than 60 cm wide for a 500 MHz-wide pulse and less than 23 cm for a 1.3 GHz-bandwidth pulse. Because the bandwidth is so wide and width in real space is so narrow, very precise time-of-flight measurements can be obtained.

Each one of ranging messages (also referred to as frames or packets) can include a sequence of pulses, which can represent information that is modulated. Each data symbol in a frame can be a sequence. The packets can have a preamble that includes header information, e.g., of a physical layer and a media access control (MAC) layer and may include a destination address. In some implementations, a packet frame can include a synchronization part and a start frame delimiter, which can line up timing.

A packet can include how security is configured and include encrypted information, e.g., an identifier of which antenna sent the packet. The encrypted information can be used for further authentication. However, for a ranging operation, the content of the data may not need to be determined. In some embodiments, a timestamp for a pulse of a particular piece of data can be used to track a difference between transmission and reception. Content (e.g., decrypted content) can be used to match pulses so that the correct differences in times can be computed. In some implementations, the encrypted information can include an indicator that authenticates which stage the message corresponds, e.g., ranging requests 101 can correspond to stage 1 and ranging responses 102 can correspond to stage 2. Such use of an indicator may be helpful when more than two devices are performing ranging operations in near each other.

The narrow pulses (e.g., ˜one nanosecond width) can be used to accurately determine a distance. The high bandwidth (e.g., 500 MHz of spectrum) allows the narrow pulse and accurate location determination. A cross correlation of the pulses can provide a timing accuracy that is a small fraction of the width of a pulse, e.g., providing accuracy within hundreds or tens of picoseconds, which provides a sub-meter level of ranging accuracy. The pulses can represent a ranging waveform of plus l's and minus l's in some pattern that is recognized by a receiver. The distance measurement can use a round trip time measurement, also referred to as a time-of-flight measurement. As described above, the mobile device can send a set of timestamps, which can remove a necessity of clock synchronization between the two devices.

### II. Altitude Measurements

Atmospheric pressure at one location can approximate correspond to the weight of the air above that location. This atmospheric pressure, also called barometric pressure or air pressure, can vary with altitude. The atmospheric pressure can be measured with a barometer, and, as the barometer's altitude increases, the amount of air above the barometer decreases. Similarly, as the barometer's altitude decreases, the amount of air above the barometer decreases. Because of the correspondence between the weight of the air and the atmospheric pressure, atmospheric pressure readings will generally decrease as a barometer's altitude increases and the pressure will increase as the barometer's altitude decreases.

Barometric pressure may also vary due to weather conditions and other climatic phenomenon. For instance, atmospheric density may vary due to the Earth's day-night cycle. During the day, solar radiation heats air causing the air to expand and pressure to decrease. At night, the atmosphere cools and the atmospheric pressure can increase as the air condenses. While climatic phenomenon may cause variations in pressure, these changes generally occur over relatively longer timescales than fluctuations caused by altitude changes. For instance, fluctuations in atmospheric pressure caused by the day-night cycle occur gradually over 12-24 hours while a pressure change caused by a device moving between floors can occur within minutes.

Climatic changes in atmospheric pressure can complicate attempts to determine absolute altitude from barometer readings. For instance, cloud cover can cause decreased temperature during the day, by shielding the Earth's surface from solar radiation, and increased temperature at night by absorbing heat energy radiating from the surface. Accordingly, an atmospheric pressure reading at a particular altitude can vary from day to day. In addition, the atmospheric pressure measurements for a particular altitude can vary between barometers. However, the measurements of a particular barometer can be used to measure the relative change in altitude of that barometer over short timescales.

The relationship between atmospheric pressure in the troposphere (e.g., the lowest layer of the atmosphere) and altitude is given by the following formula:

$$P = {{P}_{b} [ \frac{{T}_{b} - ( h - {h}_{b} ) {L}_{b}}{{T}_{b}} ]}^{\frac{{g}_{0} M}{{R}^{*} {L}_{b}}}$$

Where P is the current pressure, P_{b} is the reference pressure, T_{b} is the reference temperature (in Kelvin), L_{b} is the temperature lapse rate (in Kelvin/meter), h is the altitude of the current measurement (in meters), he is the reference altitude (in meters), R* is the universal gas constant (8.3144598 Joules/(moles*Kelvin), go is the gravitational acceleration (9.80665 meters/second²), and M is the molar mass of air (0.0289644 kilograms/mole). The reference values, with the b subscript, can correspond to measurements from a first time period, and the equation can be rearranged to solve for the current altitude h.
III. Relative Altitude from Pressure Measurements on One Device

### A. Use Cases

The tracking mobile device can use air pressure measurements to determine changes in the device's altitude. The tracking mobile device can compare these changes in altitude to ranging measurement with a target device to determine if target is above or below the tracking device.

### 1. Target Above the Device

Vertical movement can be used to determine if a target mobile device is above the tracking mobile device. The tracked device may be above the tracking device if the distance between the devices, as determined by ranging measurements, decreases when the tracking mobile device increases in altitude. Alternatively, if the target mobile device decreases in altitude, and the distance increases, then the target mobile device may be above the tracking mobile device.

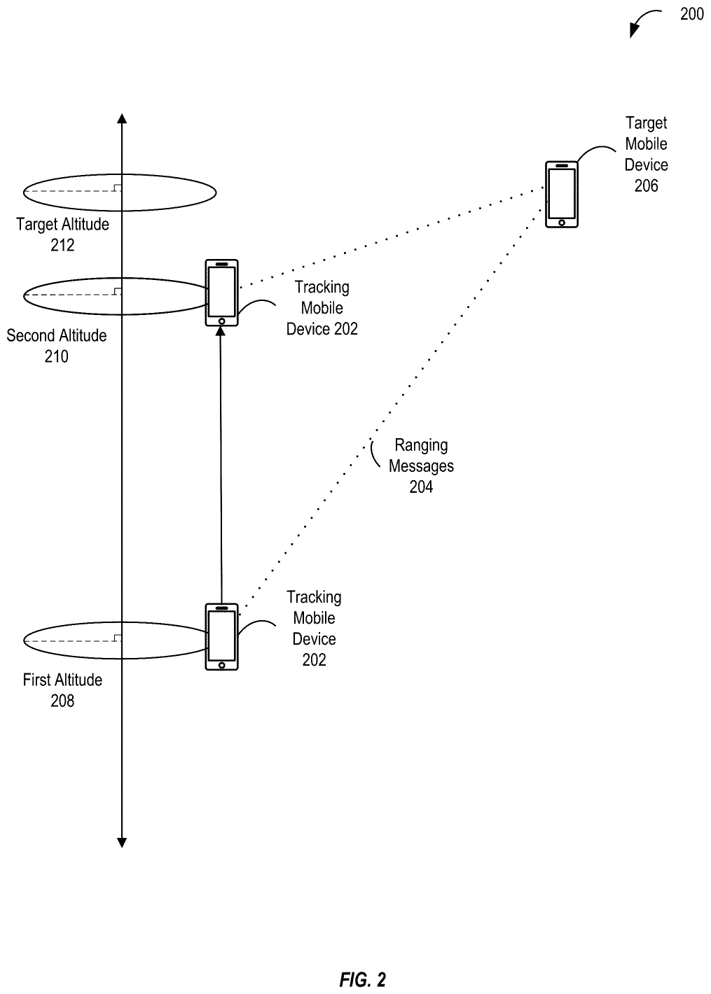

FIG. 2 show a simplified diagram 200 showing how increasing altitude can be used to determine that the target mobile device is above the tracking mobile device according to various embodiments. Tracking mobile device 202 can be any portable electronic device that is capable of exchanging ranging messages 204 with another electronic device. The tracking mobile device 202 can be exchanging the ranging messages 204 in order to determine the location of a target mobile device 206. The ranging messages 204 can be ultrawideband messages as described above in section I.

The tracking mobile device 202 can be held by a user who is searching for the target mobile device 206. The user may be holding the device at approximately the first altitude 208 during the search. A graphical user interface shown on a display of the tracking mobile device 202 may instruct the user to hold the device at a consistent altitude (e.g., within a threshold distance of the first altitude 208) in some embodiments. In some embodiments, there may be no instruction to hold the tracking mobile device 202 at a particular altitude, or to have the user change altitudes, and the changes in altitude may be opportunistic.

During the search, the tracking mobile device 202 may determine that the target mobile device 206 (e.g., the tracked mobile device) is not located at the first altitude 208. The determination can be reached in response to the distance between the tracking mobile device 202 and the target mobile device 206 staying above a threshold distance until the conclusion of a search timer. For example, the tracking mobile device 202 may determine that the target mobile device 206 is not at the first altitude 208 if the tracking mobile device 202 has been in a searching mode for longer than 5 minutes without getting within 10 feet of the target mobile device 206. In some embodiments, the tracking mobile device 202 may conclude that the target mobile device is not located at the first altitude 208 in response to detecting that the tracking mobile device 203 is at a minima. For example, the tracking mobile device 202 may determine that the device is at a point where the distance between the tracking mobile device 202 and the target mobile device 206 has been minimized (e.g., movement laterally in any direction only increases the distance).

The tracking mobile device 202 can move from the first altitude 208 to the second altitude 210. This movement can be in response to a determination that the tracking mobile device 202 and the target mobile device 206 are not at the same altitude, or the movement can occur naturally as the user searches for the target mobile device 206. The first altitude 208 and the second altitude 210 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 202 can measure the distance to the target mobile device 206 at the second altitude 210. This distance can be measured with ranging messages 204. The distance measured at the second altitude 210 can be compared to a distance measured at the first altitude 208. As shown in diagram 200, the second altitude 210 is above the first altitude 208. The distance between the tracking mobile device 202 and the target mobile device 206 should decrease as the altitude of the tracking mobile device 202 increases as the device moves to the second altitude 210. This decrease indicates that the target altitude 212, corresponding to the location of the target mobile device 206 is above both the first altitude 208 and the second altitude 210. One or more of the target altitude 212, the first altitude 208, and the second altitude 210 can be on the same floor or all of them can be on different floors.

While an increase in altitude can be used to determine that a target mobile device is located above the tracking mobile device, a decrease in altitude can also be used to determine that the tracking device (e.g., the tracking mobile device) is below the target device. The target mobile device may be on the same floor as the tracking mobile device or on a floor that is above the tracking mobile device's current floor.

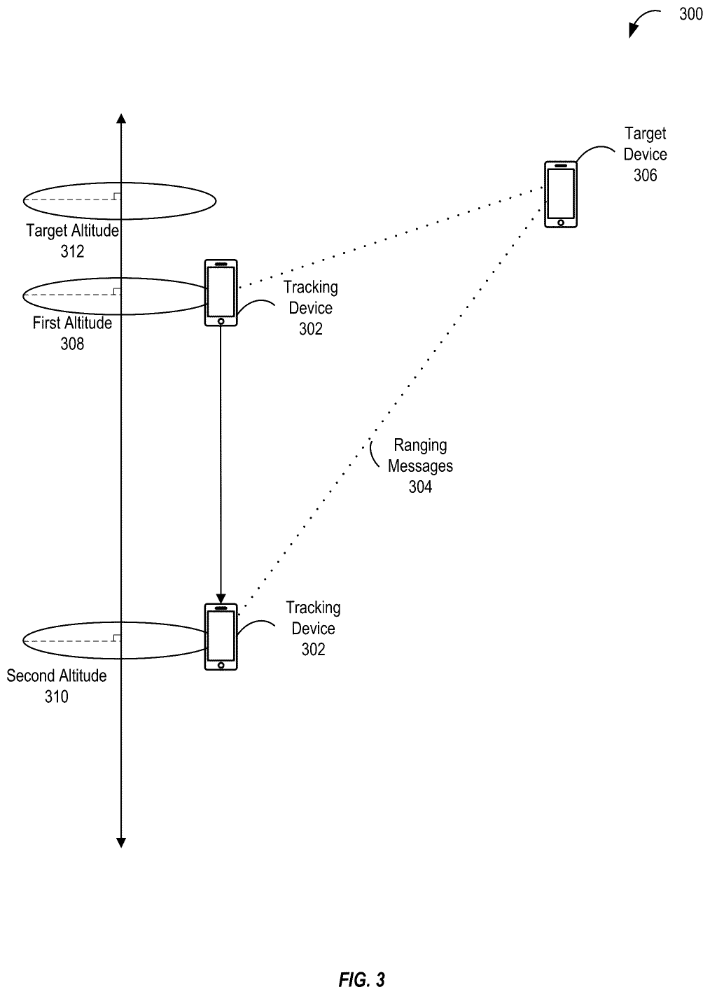

FIG. 3 show a simplified diagram 300 showing how decreasing altitude can be used to determine that the target mobile device is above the tracking mobile device according to various embodiments. Tracking mobile device 302 can be any portable electronic device that is capable of exchanging ranging messages 304 with another electronic device. For example, tracking mobile device 302 can be a mobile phone, a smart phone, a smartwatch, a tablet computer, a laptop computer, a tracking tag, etc. The tracking mobile device 302 can be exchanging the ranging messages 304 in order to determine the location of a target mobile device 306. The ranging messages 304 can be ultrawideband messages as described above in section I.

The tracking mobile device 302 can be held by a user who is searching for the target mobile device 306 as described with reference to FIG. 2. During the search, the tracking mobile device 302 may be held approximately at the first altitude 308. As shown in diagram 300, the first altitude can be between the second altitude and the target altitude 312. During the search, the tracking mobile device 302 may determine that the target mobile device 306 (e.g., the tracked mobile device) is not located at the first altitude 308. For instance, if tracking mobile device 302 has access to a map of the search space, the mobile device may determine that the distance between the tracking device and the target mobile device 306 is sufficiently large that the target device cannot be located within the floor corresponding to the first altitude 308.

The tracking mobile device 302 can move from the first altitude 308 to the second altitude 310. This movement can be in response to a determination that the tracking mobile device 302 and the target mobile device 306 are not at the same altitude, or the movement can occur naturally as the user searches for the target mobile device 306. For example, the altitude of the tracking mobile device 302 may fluctuate with the user's movements while searching (e.g., fluctuations caused by crouching to search under a table). The first altitude 308 and the second altitude 310 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 302 can measure the distance to the target mobile device 306 at the second altitude 310. This distance can be measured with ranging messages 304. The distance measured at the second altitude 310 can be compared to a distance measured at the first altitude 308. As shown in diagram 300, the second altitude 310 is below the first altitude 308. The distance between the tracking mobile device 302 and the target mobile device 306 should increase as the altitude of the tracking mobile device 302 decreases as the device moves to the second altitude 310. This decrease indicates that the target altitude 312, corresponding to the location of the target mobile device 306 is above both the first altitude 308 and the second altitude 310. One or more of the target altitude 312, the first altitude 308, and the second altitude 310 can be on the same floor or all of them can be on different floors. The increase in distance may have to be above a threshold for the tracking mobile device to determine that the target altitude 312 is above the first altitude 308 and the second altitude 310. The distance may be shown on the tracking mobile device 302 and the user may be able to visually determine whether the distance is sufficient to indicate that the target mobile device 306 is located on a different floor.

### 2. Target Below the Device

Vertical movement can be used to determine if a target mobile device is above the tracking mobile device. The tracked device may be below the tracking device if the distance between the devices, as determined by ranging measurements, decreases when the tracking mobile device decreases in altitude. Alternatively, if the target mobile device increases in altitude, and the distance increases, then the target mobile device may be below the tracking mobile device.

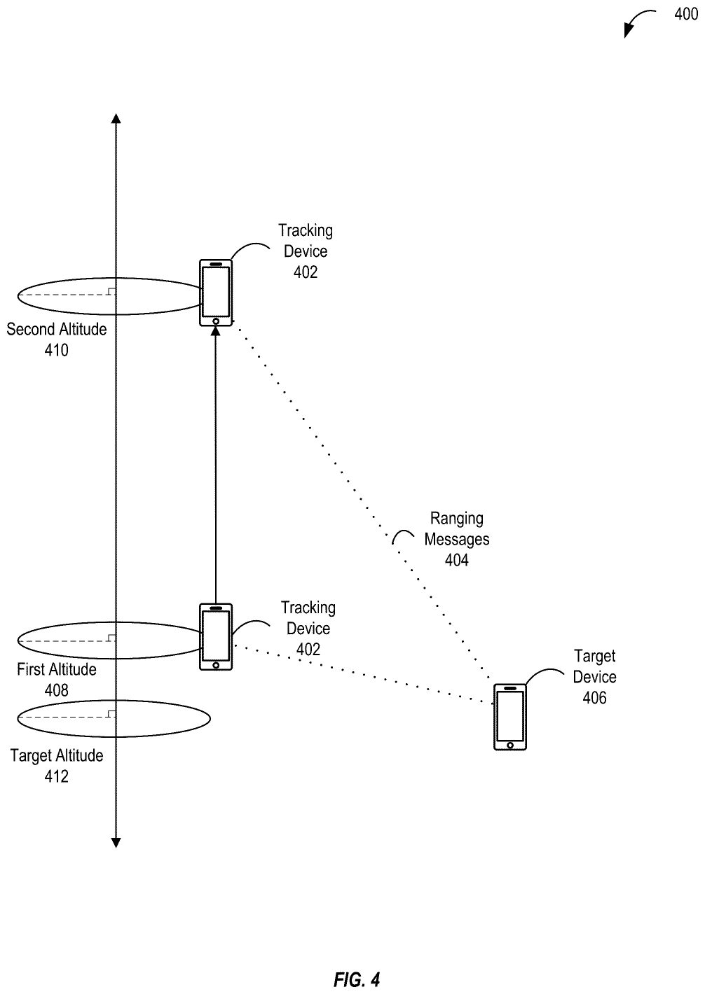

FIG. 4 show a simplified diagram 400 showing how increasing altitude can be used to determine that the target mobile device 406 is below the tracking mobile device according to various embodiments. Tracking mobile device 402 can be any portable electronic device that is capable of exchanging ranging messages 404 with another electronic device. The tracking mobile device 402 can be exchanging the ranging messages 404 in order to determine the location of a target mobile device 406. The ranging messages 404 can be ultrawideband messages as described above in section I.

The tracking mobile device 402 can be held by a user who is searching for the target mobile device 406. The user may be holding the device at approximately the first altitude 408 during the search. A graphical user interface shown on a display of the tracking mobile device 402 may instruct the user to hold the device at a consistent altitude (e.g., within a threshold distance of the first altitude 408) in some embodiments. In some embodiments, there may be no instruction to hold the tracking mobile device 402 at a particular altitude, and the changes in altitude may be opportunistic.

During the search, the tracking mobile device 402 may determine that the target mobile device 406 (e.g., the target device; the tracked mobile device) is not located at the first altitude 408. The determination can be reached in response to the distance between the tracking mobile device 402 and the target mobile device 406 staying above a threshold distance until the conclusion of a search timer. For example, the tracking mobile device 402 may determine that the target mobile device 406 is not at the first altitude 408 if the tracking mobile device 402 has been in a searching mode for longer than 8 minutes without getting within 20 feet of the target mobile device 406. In some embodiments, the tracking mobile device 402 may conclude that the target mobile device is not located at the first altitude 408 in response to detecting that the tracking mobile device 403 is at a minima. For example, the tracking mobile device 402 may determine that the device is at a point where the distance between the tracking mobile device 402 and the target mobile device 406 has been minimized (e.g., movement laterally in any direction only increases the distance).

The tracking mobile device 402 can move from the first altitude 408 to the second altitude 410. This movement can be in response to a determination that the tracking mobile device 402 and the target mobile device 406 are not at the same altitude, or the movement can occur naturally as the user searches for the target mobile device 406. The first altitude 408 and the second altitude 410 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 402 can measure the distance to the target mobile device 406 at the second altitude 410. This distance can be measured with ranging messages 404. The distance measured at the second altitude 410 can be compared to a distance measured at the first altitude 408. As shown in diagram 400, the second altitude 410 is above the first altitude 408. The distance between the tracking mobile device 402 and the target mobile device 406 should increase as the altitude of the tracking mobile device 402 increases as the device moves to the second altitude 410. This increase indicates that the target altitude 412, corresponding to the location of the target mobile device 406 is below both the first altitude 408 and the second altitude 410. One or more of the target altitude 412, the first altitude 408, and the second altitude 410 can be on the same floor or all of them can be on different floors.

While an increase in altitude can be used to determine that a target mobile device is located below the tracking mobile device, a decrease in altitude can also be used to determine that the target device is below the tracking device. The target mobile device may be on the same floor as the tracking mobile device or on a floor that is below the tracking mobile device's current floor.

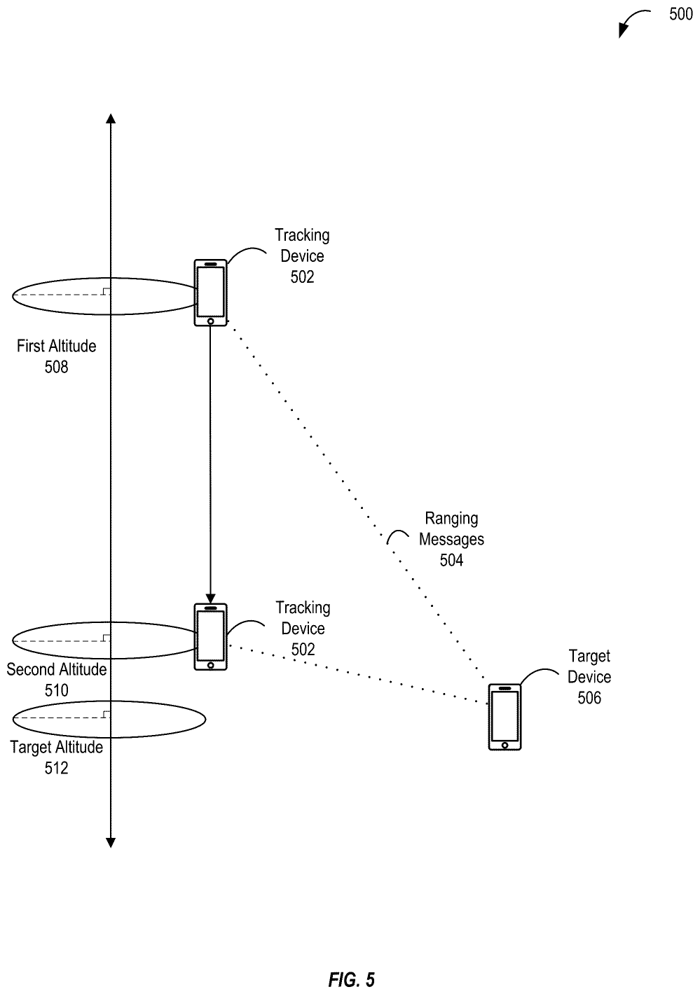

FIG. 5 show a simplified diagram 500 showing how decreasing altitude can be used to determine that the target mobile device is below the tracking mobile device according to various embodiments. Tracking mobile device 502 can be any portable electronic device that is capable of exchanging ranging messages 504 with another electronic device. For example, tracking mobile device 502 can be a mobile phone, a smart phone, a smartwatch, a tablet computer, a laptop computer, a tracking tag, etc. The tracking mobile device 502 can be exchanging the ranging messages 504 in order to determine the location of a target mobile device 506. The ranging messages 504 can be ultrawideband messages as described above in section I.

The tracking mobile device 502 can be held by a user who is searching for the target mobile device 506 as described with reference to FIG. 4. During the search, the tracking mobile device 502 may be held approximately at the first altitude 508. As shown in diagram 500, the first altitude can be above both the second altitude and the target altitude 512. During the search, the tracking mobile device 502 may determine that the target mobile device 506 (e.g., the tracked mobile device) is not located at the first altitude 508. For instance, if tracking mobile device 502 has access to a map of the search space, the mobile device may determine that the distance between the tracking device and the target mobile device 506 is sufficiently large that the target device cannot be located within the floor corresponding to the first altitude 508.

The tracking mobile device 502 can move from the first altitude 508 to the second altitude 510. This movement can be in response to a determination that the tracking mobile device 502 and the target mobile device 506 are not at the same altitude, or the movement can occur naturally as the user searches for the target mobile device 506. For example, the altitude of the tracking mobile device 502 may fluctuate with the user's movements while searching (e.g., fluctuations caused by placing the tracking device down to search through couch cushions). The first altitude 508 and the second altitude 510 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 502 can measure the distance to the target mobile device 506 at the second altitude 510. This distance can be measured with ranging messages 504. The distance measured at the second altitude 510 can be compared to a distance measured at the first altitude 508. As shown in diagram 500, the second altitude 510 is below the first altitude 508. The distance between the tracking mobile device 502 and the target mobile device 506 should decrease as the altitude of the tracking mobile device 502 decreases as the device moves to the second altitude 510. This decrease indicates that the target altitude 512, corresponding to the location of the target mobile device 506 is below both the first altitude 508 and the second altitude 510. One or more of the target altitude 512, the first altitude 508, and the second altitude 510 can be on the same floor or all of them can be on different floors. The decrease in distance may have to be above a threshold for the tracking mobile device to determine that the target altitude 512 is below the first altitude 508 and the second altitude 510. The distance may be shown on the tracking mobile device 502 and the user may be able to visually determine whether the distance is sufficient to indicate that the target mobile device 506 is located on a different floor.

### 3. Target Between the First and Second Altitude

Vertical movement can be used to determine that a target mobile device is at approximately the same altitude as the tracking mobile device. If the tracking mobile device moves from a first altitude to a second altitude, without a significant change in the distance between the devices, then the target mobile device may be located between the two altitudes.

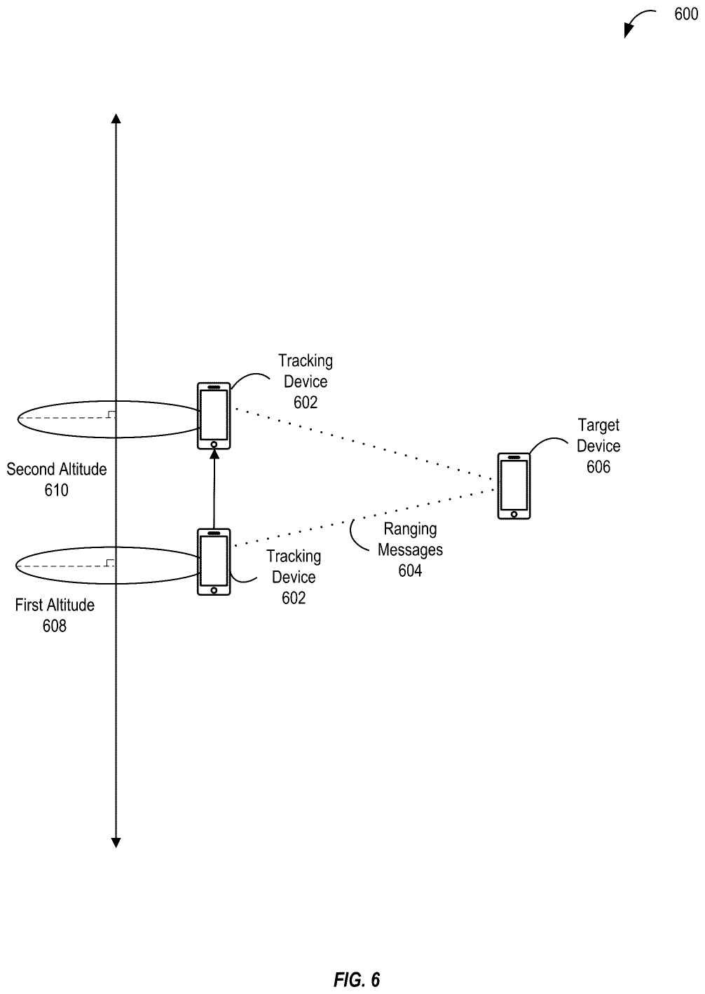

FIG. 6 show a simplified diagram 600 showing how increasing altitude can be used to determine that the target mobile device 606 is approximately at the same altitude as the tracking mobile device according to various embodiments. Tracking mobile device 602 can be any portable electronic device that is capable of exchanging ranging messages 604 with another electronic device. The tracking mobile device 602 can be exchanging the ranging messages 604 in order to determine the location of a target mobile device 606. The ranging messages 604 can be ultrawideband messages as described above in section I.

The tracking mobile device 602 can be held by a user who is searching for the target mobile device 606. The user may be holding the device at approximately the first altitude 608 during the search. A graphical user interface shown on a display of the tracking mobile device 602 may instruct the user to hold the device at a consistent altitude (e.g., within a threshold distance of the first altitude 608) in some embodiments. In some embodiments, there may be no instruction to hold the tracking mobile device 602 at a particular altitude, and the changes in altitude may be opportunistic.

During the search, the tracking mobile device 602 may determine that the tracking device should check if the target mobile device 606 (e.g., the target device; the tracked mobile device) is located at the first altitude 608. The determination can be reached in response to the distance between the tracking mobile device 602 and the target mobile device 606 staying above a threshold distance until the conclusion of a search timer. For example, the tracking mobile device 602 may determine that the tracking device should check whether the target mobile device 606 is at the first altitude 608 if the tracking mobile device 602 has been in a searching mode for longer than 15 minutes without getting within 12 feet of the target mobile device 606. In some embodiments, the tracking mobile device 602 may conclude that the tracking mobile device should check whether the target mobile device 606 is located at the first altitude 608 at the onset of a search (e.g., so that a user does not spend time searching the floor unnecessarily). For example, the tracking mobile device 602 may determine that the tracking mobile device should check whether the target mobile device 606 is on the current floor whenever the tracking device detects that the tracking mobile device has changed floors (e.g., using simultaneous localization and mapping techniques).

The tracking mobile device 602 can move from the first altitude 608 to the second altitude 610. This movement can be in response to a determination that the tracking mobile device 602 should check whether the target mobile device 606 is at the same altitude as the tracking device, or the movement can occur naturally as the user searches for the target mobile device 606. The first altitude 608 and the second altitude 610 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 602 can measure the distance to the target mobile device 606 at the second altitude 610. This distance can be measured with ranging messages 604. The distance measured at the second altitude 610 can be compared to a distance measured at the first altitude 608. As shown in diagram 600, the second altitude 610 is above the first altitude 608. As shown in diagram 600, the distance between the tracking mobile device 602 and the target mobile device 606 should stay at approximately the same magnitude as the altitude of the tracking mobile device 602 increases as the device moves to the second altitude 610. This stable distance can indicate that the target mobile device 606 is within a threshold distance of both the first altitude 608 and the second altitude 610. One or more of the first altitude 608, and the second altitude 610 can be on the same floor or both of them can be on different floors.

While an increase in altitude can be used to determine that a target mobile device is located at approximately the same altitude as the tracking mobile device, a decrease in altitude can also be used to determine that the target device and the tracking device are at similar altitudes.

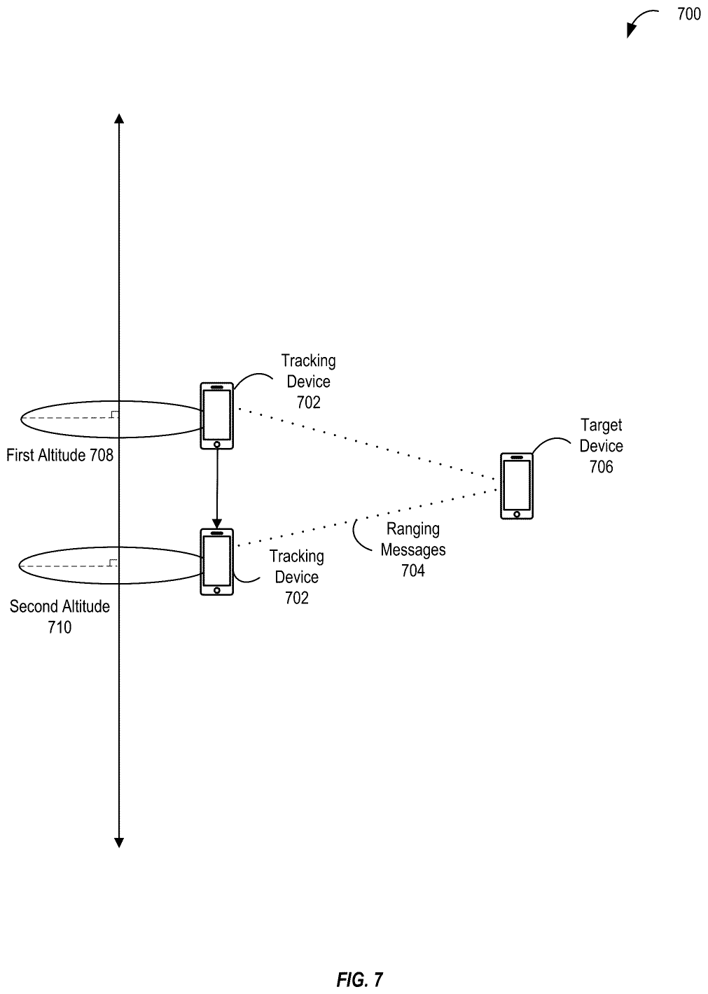

FIG. 7 show a simplified diagram 700 showing how decreasing altitude can be used to determine that the target mobile device is approximately at the same altitude as the tracking mobile device according to various embodiments. Tracking mobile device 702 can be any portable electronic device that is capable of exchanging ranging messages 704 with another electronic device. For example, tracking mobile device 702 can be a mobile phone, a smart phone, a smartwatch, a tablet computer, a laptop computer, a tracking tag, etc. The tracking mobile device 702 can be exchanging the ranging messages 704 in order to determine the location of a target mobile device 706. The ranging messages 704 can be ultrawideband messages as described above in section I.

The tracking mobile device 702 can be held by a user who is searching for the target mobile device 706 as described with reference to FIG. 6. During the search, the tracking mobile device 702 may be held approximately at the first altitude 708. As shown in diagram 700, the target mobile device 706 can be located at approximately the same altitude as the tracking mobile device 702. For example, the target mobile device 706 and the tracking mobile device 702 may be located within a threshold distance of each other. This threshold can be a vertical distance of 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m. During the search, the tracking mobile device 702 may determine that the target mobile device 706 (e.g., the tracked mobile device) should determine whether the target mobile device 706 is at the first altitude 708.

The tracking mobile device 702 can move from the first altitude 708 to the second altitude 710. This movement can be in response to a determination that the tracking mobile device 702 and the target mobile device 706 are not at the same altitude, or the movement can occur naturally as the user searches for the target mobile device 706. For example, the altitude of the tracking mobile device 702 may fluctuate with the user's movements while searching (e.g., fluctuations caused by using a phone's light to search a closet). The first altitude 708 and the second altitude 710 may be located on the same floor or separate floors of a building. The distance between the first altitude and the second altitude can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m.

The tracking mobile device 702 can measure the distance to the target mobile device 706 at the second altitude 710. This distance can be measured with ranging messages 704. The distance measured at the second altitude 710 can be compared to a distance measured at the first altitude 708. As shown in diagram 700, the second altitude 710 is below the first altitude 708. The distance between the tracking mobile device 702 and the target mobile device 706 may stay approximately the same (e.g., within a threshold distance) as the device moves to the second altitude 710. This threshold distance can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m. This stable distance measurement can indicate that the target mobile device 706 is below both the first altitude 708 and the second altitude 710. One or more of the first altitude 708 and the second altitude 710 can be on the same floor or both of them can be on different floors. The distance may be shown on the tracking mobile device 702 and the user may be able to visually determine whether the distance is sufficient to indicate that the target mobile device 706 is located on a different floor.

### B. Method Flow

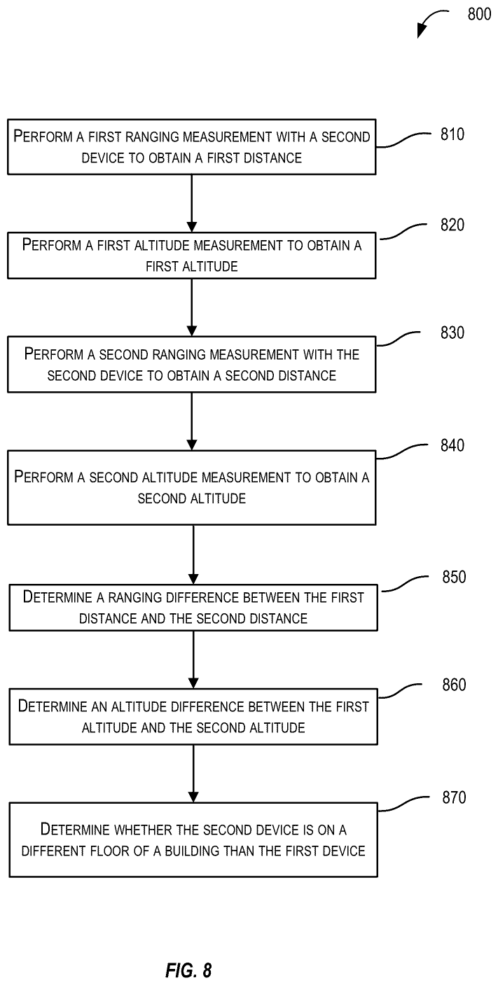

FIG. 8 is a simplified flowchart of a technique for determining the vertical position of a target mobile device using altitude measurements from a single device according to at least one embodiment. In some implementations, one or more method blocks of FIG. 8 may be performed by an electronic device (e.g., mobile device 1100, device 1200, tracking mobile device 202, tracking mobile device 302, tracking mobile device 402, tracking mobile device, 502, tracking mobile device 602, or tracking mobile device 702). In some implementations, one or more method blocks of FIG. 8 may be performed by another device or a group of devices separate from or including the electronic device.

At block 810, a first ranging measurement can be performed with a second device to obtain a first distance. The first ranging measurement can be performed at a first time. The first ranging measurement may be performed by exchanging messages between the first mobile device and a second mobile device. The first mobile device can be a tracking mobile device and the second mobile device can be a target mobile device. The distance can correspond to a distance between the tracking mobile device and the target mobile device (e.g., target mobile device 206, target mobile device 306, target mobile device 406, target mobile device 506, target mobile device 606, target mobile device 706). The exchanged messages may be ultrawideband messages, and the distance can be calculated from the time of flight and the received signal strength of the messages. The measurement may be performed by a first sensor such as UWB antennas 1110, UWB circuitry 1115, BT/WiFi antenna 1120, BT/WiFi Circuitry 1125.

At block 820, a first altitude measurement may be performed to obtain a first altitude. The first altitude may be measured at the first time, however the first ranging measurement and the first altitude measurement may be performed at the same time or at different times. The first altitude measurement may identify a particular altitude (e.g., 2,000 meters above sea level), a range of altitudes (e.g., 1,000-1,200 feet above sea level), or a direction of change in altitude (e.g., an increase in altitude), or an air pressure reading (e.g., 760 millimeters of mercury (mmHg)). The altitude measurement may be performed by a second sensor such as a barometer (e.g., sensors 1246). During the first altitude measurement, a display of the first mobile device may provide instructions to hold the first mobile device at a first altitude. For example, the instructions can be text indicating that the device should be held steady or a graphical user interface displaying graphics that induce the user to hold the first mobile device steady (e.g., the screen changes colors if the sensors of the mobile device detect vertical motion.

At block 830, a second ranging measurement can be performed to obtain a second distance. The second ranging measurement can be performed at a second time. The second ranging measurement can be performed by the first sensor to obtain the second distance. In some embodiments, one or more of the first distance or the second distance can be performed by the second mobile device and provided to the first mobile device.

At block 840, a second altitude measurement can be performed to obtain a second altitude. The second altitude measurement can be performed at the second time. The second ranging measurement and the second altitude measurement may be performed at different times in some embodiments. A display of the first mobile device may display text or graphics that are intended to induce a user holding the first mobile device to change altitudes. For example, the display may show text instructing the user to change altitudes, or images on a graphical user interface that displayed on the first mobile device may induce the user to change altitudes (e.g., a bar that fills as the first mobile device changes altitudes).

At block 850, a ranging difference between the first distance and the second distance may be determined. The ranging difference may be determined by the first mobile device, or the second mobile device may determine the ranging difference and provide the ranging difference to the first mobile device. In some embodiments, a third device, such as a server computer, may determine the ranging difference.

At block 860, an altitude difference between the first altitude and the second altitude may be determined. The altitude difference may be determined by the first mobile device, the second mobile device, or a third mobile device such as a personal computer. The altitude difference can be a direction and magnitude of the altitude difference (e.g., 30-foot increase in altitude), or a direction of altitude difference (e.g., a decrease in altitude).

At block 870, whether the second mobile device is on a different floor of a building than the first device can be determined. The determination can be made in response to the altitude difference exceeding a threshold (e.g., above 12 feet), the ranging difference exceeding a threshold (e.g., 10 meters), or both. A notification may be displayed on a display of the first device. The notification indicating that the second device is on the different floor of the building. The determination may indicate one or more floors of the building that may contain the second mobile device. For example, the determination may indicate that the second mobile device is below the first mobile device. In some embodiments, the determination may indicate that the first mobile device and the second mobile device are on the same floor. In such cases, the determination may indicate a relative altitude of each device (e.g., the second mobile device is on the current floor but below the first mobile device).

IV. Relative Altitude from Pressure Measurements on Two Devices

Readings may vary between air pressure sensors. This variance can mean that the magnitude of an altitude measurement calculated from an air pressure reading from a first sensor can vary significantly from the magnitude of a contemporaneous air pressure measurement by a second sensor. Such variance can complicate attempts to use the magnitude altitude measurements derived from air pressure readings on separate devices to determine the relative positions of those devices. However, the direction of change in each device's altitude measurements may be used to determine whether a target mobile device is located above or below a tracking mobile device.

### A. Comparing Pressure Measurements to Determine Altitude

The pressure readings from air pressure sensors can be calibrated when the sensors are collocated at a particular altitude. While moving, the devices can track their altitude relative to the particular altitude. If the devices become separated, the tracking mobile device can determine whether it is above, below, or at the same altitude as the target mobile device using the displacement of each device from the particular altitude.

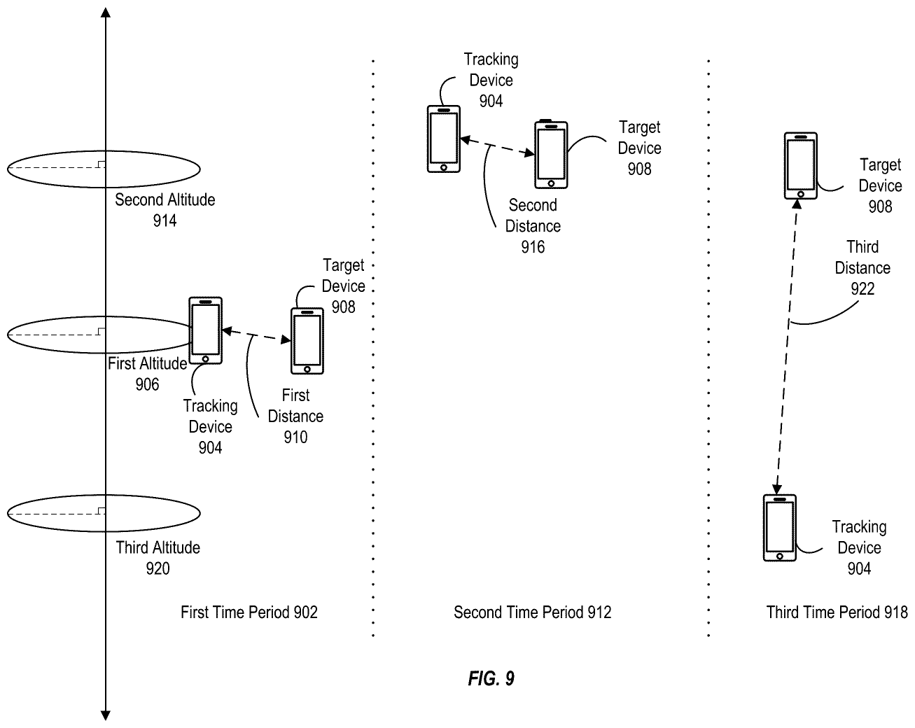

FIG. 9 shows a simplified diagram showing a tracking mobile device determining the altitude of a target mobile device using altitude measurements from multiple devices according to at least one embodiment. At a first time period 902, the tracking mobile device 904 (e.g., the tracking device) can be located at a first altitude 906 along with a target mobile device 908. The tracking mobile device 904 and the target mobile device 908 can be separated by a first distance 910. The first distance can be a distance that is sufficiently small that the two devices are likely to be at approximately the same altitude (e.g., within a proximity threshold). For example, if the first distance is 4 feet, it is likely that the two devices are located on the same floor. The distances can be determined using ranging measurements as described in section I.

If the first distance 910 is below a proximity threshold, the tracking mobile device 904 and the target mobile device 908 can each measure the air pressure to determine an altitude measurement. The air pressure on each device can be measured with an air pressure sensor such as a digital barometer. Each device may take the air pressure reading in response to detecting that the first distance 910 is below the proximity threshold, or a user can prompt the devices to perform the measurement by providing input to one or more of the devices (e.g., button push). The air pressure measurement may be triggered at one device by a message sent by the other device. For example, the tracking mobile device 904 can detect that the first distance 910 is below the proximity threshold. The proximity threshold can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m. In response, the tracking mobile device 904 can measure the air pressure and sent a message to the target mobile device 908. The message can be in the payload of a ranging message and the message can prompt the target mobile device 908 to measure the air pressure.

At a second time period 912, the tracking mobile device 904 and the target mobile device 908 can move from the first altitude 906 to the second altitude 914. The tracking mobile device 904 and the target mobile device 908 may be separated by a second distance 916 at the second time period 912. The two devices may record air pressure readings at regular intervals, or in response to a trigger. In some embodiments, the two devices may not perform altitude measurements, after the initial altitude measurements, until the distance between the tracking mobile device 904 and the target mobile device 908 exceeds a distance threshold. The distance threshold can be 1 centimeter (cm), 10 cm, 15 cm, 20 cm, 30 cm, 40 cm, 50 cm, 1 meter (m), 2 m, 3 m, 4 m, 5 m, 10 m, 20 m, 30 m, 40 m, 50 m, and 100 m. The distance can be determined by exchanging ranging messages between the devices as described above in section I.

At a third time period 918, the tracking mobile device 904 can move to a third altitude 920 while the target mobile device 908 remains at the second altitude 914. After this movement, the two devices are separated by a third distance 922. The third distance can exceed the distance threshold and the exceeded distance threshold can trigger each device to perform air pressure measurements. These air pressure measurements can be compared to the air pressure measurements made at the first time period 902. The comparison can be used to determine a direction for the change in each device's altitude (e.g., increased altitude, decreased altitude, or the same altitude). In some embodiments, the magnitude of the change in altitude, or the absolute magnitude of the altitude can be calculated.

### B. Method Flow

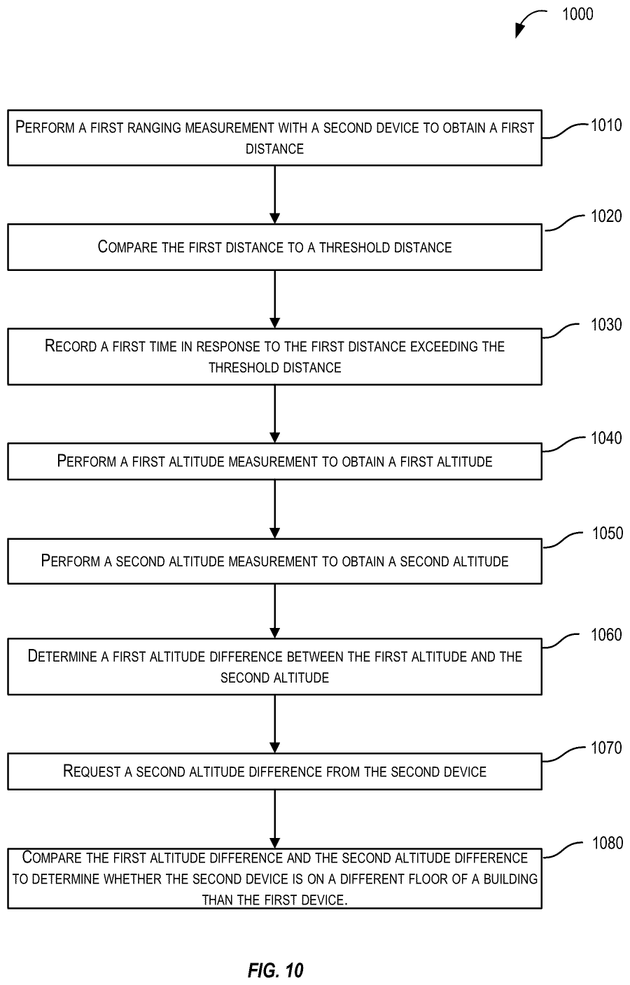

FIG. 10 is a simplified flowchart of a technique for determining the vertical position of a target mobile device using altitude measurements from multiple devices according to at least one embodiment. In some implementations, one or more method blocks of FIG. 10 may be performed by an electronic device (e.g., mobile device 1100, device 1200, tracking mobile device 202, tracking mobile device 302, tracking mobile device 402, tracking mobile device, 502, tracking mobile device 602, or tracking mobile device 702). In some implementations, one or more method blocks of FIG. 10 may be performed by another device or a group of devices separate from or including the electronic device.

At block 1010, a first ranging measurement can be performed with a second device to obtain a first distance. The first ranging measurement can be performed at a first time. The first ranging measurement may be performed by exchanging messages between the first mobile device and a second mobile device. The first mobile device can be a tracking mobile device and the second mobile device can be a target mobile device. The distance can correspond to a distance between the tracking mobile device and the target mobile device (e.g., target mobile device 206, target mobile device 306, target mobile device 406, target mobile device 506, target mobile device 606, target mobile device 706). The exchanged messages may be ultrawideband messages, and the distance can be calculated from the time of flight and the received signal strength of the messages. The measurement may be performed by a first sensor such as UWB antennas 1110, UWB circuitry 1115, BT/WiFi antenna 1120, BT/WiFi Circuitry 1125.

At block 1020, the first distance can be compared to a threshold distance. The threshold distance can be the proximity threshold. The threshold distance can be a distance magnitude (e.g., 7 feet) or a value calculated from a ranging measurement (e.g., 0.2 second time of flight).

At block 1030, a first time can be recorded in response to the first distance exceeding the threshold distance. The first time can correspond to the time when the ranging measurement was performed, or a time when the first altitude measurement was performed.

At block 1040, a first altitude measurement can be performed to obtain a first altitude. The first altitude may be measured at the first time, however the first ranging measurement and the first altitude measurement may be performed at the same time or at different times. The first altitude measurement may identify a particular altitude (e.g., 2,000 meters above sea level), a range of altitudes (e.g., 1,000-1,200 feet above sea level), or a direction of change in altitude (e.g., an increase in altitude), or an air pressure reading (e.g., 760 millimeters of mercury (mmHg)). The altitude measurement may be performed by a second sensor such as a barometer (e.g., sensors 1246). During the first altitude measurement, a display of the first mobile device may provide instructions to hold the first mobile device at a first altitude. For example, the instructions can be text indicating that the device should be held steady or a graphical user interface displaying graphics that induce the user to hold the first mobile device steady (e.g., the screen changes colors if the sensors of the mobile device detect vertical motion.

At block 1050, a second altitude measurement can be performed to obtain a second altitude. The second altitude measurement can be performed at a second time. The second altitude measurement can be performed by the second sensor. The second sensor can be an air pressure sensor such as a barometer.

At block 1060, a first altitude difference between the first altitude and the second altitude can be determined. The altitude difference may be determined by the first mobile device, the second mobile device, or a third mobile device such as a personal computer. The altitude difference can be a direction and magnitude of the altitude difference (e.g., 30-foot increase in altitude), or a direction of altitude difference (e.g., a decrease in altitude).

At block 1070, a second altitude difference can be requested from the second device. The altitude difference may be determined by the first mobile device, the second mobile device, or a third mobile device such as a personal computer. For example, the second mobile device may provide altitude measurements to the first mobile device, in response to the request, and the first mobile device may calculate the difference. The altitude difference can be a direction and magnitude of the altitude difference (e.g., 30-foot increase in altitude), or a direction of altitude difference (e.g., a decrease in altitude).

At block 1080, the first altitude difference and the second altitude difference can be compared to determine whether the second device is on a different floor of a building than the first device.

### V. UWB Device

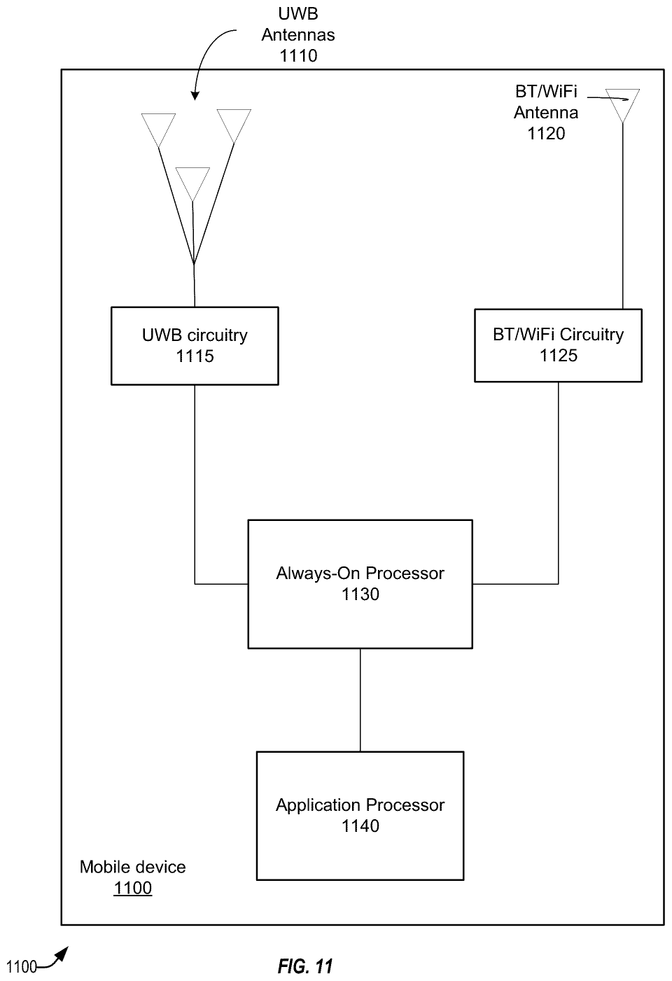

FIG. 11 is a block diagram of components of a mobile device 1100 operable to perform ranging according to embodiments of the present disclosure. Mobile device 1100 includes antennas for at least two different wireless protocols, as described above. The first wireless protocol (e.g., Bluetooth) may be used for authentication and exchanging ranging settings. The second wireless protocol (e.g., UWB) may be used for performing ranging with another mobile device.

As shown, mobile device 1100 includes UWB antennas 1110 for performing ranging. UWB antennas 1110 are connected to UWB circuitry 1115 for analyzing detected signals from UWB antennas 1110. In some embodiments, mobile device 1100 includes three or more UWB antennas, e.g., for performing triangulation. The different UWB antennas can have different orientations, e.g., two in one direction and a third in another direction. The orientations of the UWB antennas can define a field of view for ranging. As an example, the field of view can span 120 degrees. Such regulation can allow a determination of which direction a user is pointing a device relative to one or more other nearby devices. The field of view may include any one or more of pitch, yaw, or roll angles.

UWB circuitry 1115 can communicate with an always-on processor (AOP) 1130, which can perform further processing using information from UWB messages. For example, AOP 1130 can perform the ranging calculations using timing data provided by UWB circuitry 1115. AOP 1130 and other circuits of the device can include dedicated circuitry and/or configurable circuitry, e.g., via firmware or other software.

As shown, mobile device 1100 also includes Bluetooth (BT)/Wi-Fi antenna 1120 for communicating data with other devices. Bluetooth (BT)/Wi-Fi antenna 1120 is connected to BT/Wi-Fi circuitry 1125 for analyzing detected signals from BT/Wi-Fi antenna 1120. For example, BT/Wi-Fi circuitry 1125 can parse messages to obtain data (e.g., an authentication tag), which can be sent on to AOP 1130. In some embodiments, AOP 1130 can perform authentication using an authentication tag. Thus, AOP 1130 can store or retrieve a list of authentication tags for which to compare a received tag against, as part of an authentication process. In some implementations, such functionality could be achieved by BT/Wi-Fi circuitry 1125.

In other embodiments, UWB circuitry 1115 and BT/Wi-Fi circuitry 1125 can alternatively or in addition be connected to application processor 1140, which can perform similar functionality as AOP 1130. Application processor 1140 typically requires more power than AOP 1130, and thus power can be saved by AOP 1130 handling certain functionality, so that application processor 1140 can remain in a sleep state, e.g., an off state. As an example, application processor 1140 can be used for communicating audio or video using BT/Wi-Fi, while AOP 1130 can coordinate transmission of such content and communication between UWB circuitry 1115 and BT/Wi-Fi circuitry 1125. For instance, AOP 1130 can coordinate timing of UWB messages relative to BT advertisements.

Coordination by AOP 1130 can have various benefits. For example, a first user of a sending device may want share content with another user, and thus ranging may be desired with a receiving device of this other user. However, if many people are in the same room, the sending device may need to distinguish a particular device among the multiple devices in the room, and potentially determine which device the sending device is pointing to. Such functionality can be provided by AOP 1130. In addition, it is not desirable to wake up the application processor of every other device in the room, and thus the AOPs of the other devices can perform some processing of the messages and determine that the destination address is for a different device.

To perform ranging, BT/Wi-Fi circuitry 1125 can analyze an advertisement signal from another device to determine that the other device wants to perform ranging, e.g., as part of a process for sharing content. BT/Wi-Fi circuitry 1125 can communicate this notification to AOP 1130, which can schedule UWB circuitry 1115 to be ready to detect UWB messages from the other device.

For the device initiating ranging, its AOP can perform the ranging calculations. Further, the AOP can monitor changes in distance between the other devices. For example, AOP 1130 can compare the distance to a threshold value and provide an alert when the distance exceeds a threshold, or potentially provide a reminder when the two devices become sufficiently close. An example of the former might be when a parent wants to be alerted when a child (and presumably the child's device) is too far away. An example of the latter might be when a person wants to be reminded to bring up something when talking to a user of the other device. Such monitoring by the AOP can reduce power consumption by the application processor.

### VI. Example Device

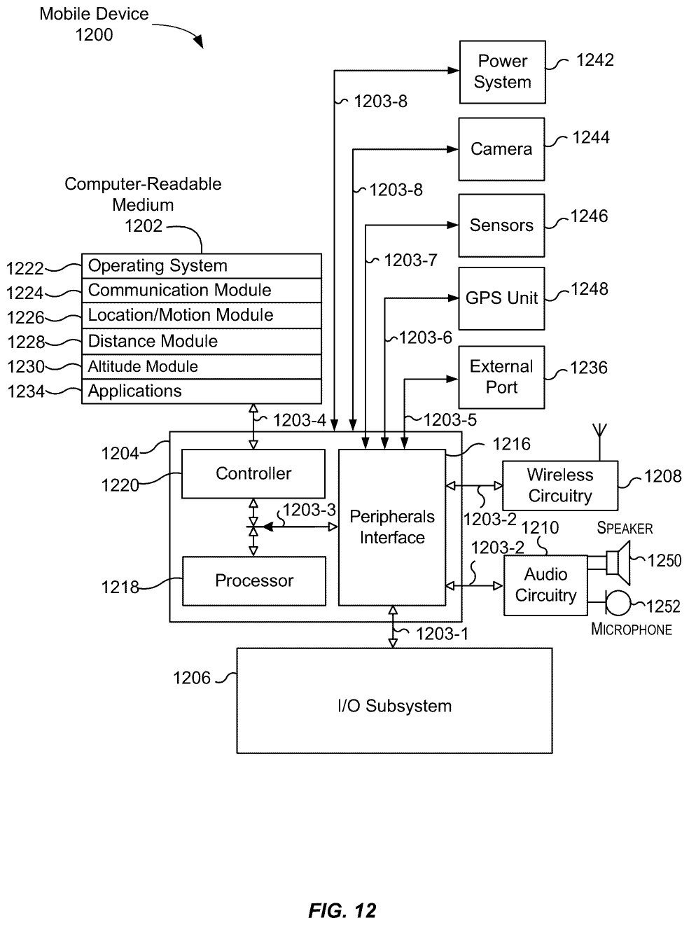

FIG. 12 is a block diagram of an example device 1200, which may be a mobile device. Device 1200 generally includes computer-readable medium 1202, a processing system 1204, an Input/Output (I/O) subsystem 1206, wireless circuitry 1208, and audio circuitry 1210 including speaker 1250 and microphone 1252. These components may be coupled by one or more communication buses or signal lines 1203. Device 1200 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 12 is only one example of an architecture for device 1200, and that device 1200 can have more or fewer components than shown, or a different configuration of components. The various components shown in FIG. 12 can be implemented in hardware, software, or a combination of both hardware and software, including one or more signal processing and/or application specific integrated circuits.

Wireless circuitry 1208 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1208 can use various protocols, e.g., as described herein.

Wireless circuitry 1208 is coupled to processing system 1204 via peripherals interface 1216. Interface 1216 can include conventional components for establishing and maintaining communication between peripherals and processing system 1204. Voice and data information received by wireless circuitry 1208 (e.g., in speech recognition or voice command applications) is sent to one or more processors 1218 via peripherals interface 1216. One or more processors 1218 are configurable to process various data formats for one or more application programs 1234 stored on medium 1202.

Peripherals interface 1216 couple the input and output peripherals of the device to processor 1218 and computer-readable medium 1202. One or more processors 1218 communicate with computer-readable medium 1202 via a controller 1220. Computer-readable medium 1202 can be any device or medium that can store code and/or data for use by one or more processors 1218. Medium 1202 can include a memory hierarchy, including cache, main memory, and secondary memory.

Device 1200 also includes a power system 1242 for powering the various hardware components. Power system 1242 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management and distribution of power in mobile devices.

In some embodiments, device 1200 includes a camera 1244. In some embodiments, device 1200 includes sensors 1246. Sensors 1246 can include accelerometers, compasses, gyrometers, pressure sensors, audio sensors, light sensors, barometers, and the like. Sensors 1246 can be used to sense location aspects, such as auditory or light signatures of a location.

In some embodiments, device 1200 can include a GPS receiver, sometimes referred to as a GPS unit 1248. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 1200 may be configured to identify GLONASS signals, or any other similar type of satellite navigational signal.

One or more processors 1218 run various software components stored in medium 1202 to perform various functions for device 1200. In some embodiments, the software components include an operating system 1222, a communication module (or set of instructions) 1224, a location module (or set of instructions) 1226, an altitude module 1230, and other applications (or set of instructions) 1234, such as a car locator app and a navigation app. The altitude module 1230 can use information from a barometer, or another air pressure sensor, to calculate the altitude of mobile device 1200, or relative changes in the altitude of mobile device 1200.

Operating system 1222 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1224 facilitates communication with other devices over one or more external ports 1236 or via wireless circuitry 1208 and includes various software components for handling data received from wireless circuitry 1208 and/or external port 1236. External port 1236 (e.g., USB, FireWire, Lightning connector, 60-pin connector, etc.) is adapted for coupling directly to other devices or indirectly over a network (e.g., the Internet, wireless LAN, etc.).

Location/motion module 1226 can assist in determining the current position (e.g., coordinates or other geographic location identifier) and motion of device 1200. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1226 receives data from GPS unit 1248 and analyzes the signals to determine the current position of the mobile device. In some embodiments, location/motion module 1226 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1208 and is passed to location/motion module 1226. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1200 based on the position coordinates of the corresponding transmitters. Regardless of the specific location technology used, location/motion module 1226 receives information from which a location fix can be derived, interprets that information, and returns location information, such as geographic coordinates, latitude/longitude, or other location fix data.

Distance module 1228 can use information from wireless circuitry 1208, or sensors 1126, to calculate the distance between the device 1100 and one or more additional electronic devices. For example, the distance modules 1228 can calculate the time of flight of messages received at the wireless circuitry 1208 to determine the distance. Altitude module 1230 can use air pressure measurements from sensors 1246 to calculate the altitude of the device 1200. The calculated altitude can be the magnitude of the altitude of device 1200, the relative motion of device 1200, or a direction of change in altitude of device 1200.

The one or more application programs 1234 on the mobile device can include any applications installed on the device 1200, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 1206 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1206 can include a display and user input devices such as a keyboard, mouse, and/or track pad. In some embodiments, I/O subsystem 1206 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1202) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1200 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method comprising performing, by a first device:
at a first time:
performing, using a first sensor, a first ranging measurement with a second device to obtain a first distance; and
performing, using a second sensor, a first altitude measurement to obtain a first altitude;
at a second time:
performing, using the first sensor, a second ranging measurement with the second device to obtain a second distance; and
performing, using the second sensor, a second altitude measurement to obtain a second altitude;
determining a ranging difference between the first distance and the second distance; and
determining an altitude difference between the first altitude and the second altitude.

2. The method of claim 1, further comprising:
determining whether the second device is on a different floor of a building than the first device.

3. The method of claim 2, further comprising:
displaying a notification on a display of the first device, the notification indicating that the second device is on the different floor of the building than the first device.

4. The method of claim 2, wherein determining whether the second device is on the different floor comprises:
comparing the altitude difference to a threshold; and
determining that the second device is on a different floor of the building in response to the altitude difference exceeding the threshold.

5. The method of claim 2, wherein determining whether the second device is on the different floor comprises:
comparing the ranging difference to a threshold; and
determining that the second device is on a different floor of the building in response to the ranging difference exceeding the threshold.

6. The method of claim 1, wherein determining the first altitude measurement comprises:
performing a first air pressure measurement using the second sensor; and
calculating the first altitude measurement based on the first air pressure measurement.

7. The method of claim 6, wherein determining the altitude difference comprises:
subtracting a second air pressure reading corresponding to the second altitude measurement from the first air pressure measurement to calculate the altitude difference.

8. A computing device, comprising:
one or more memories; and
one or more processors in communication with the one or more memories and configured to execute instructions stored in the one or more memories to performing operations to:
at a first time:
perform, using a first sensor, a first ranging measurement with a second device to obtain a first distance; and
perform, using a second sensor, a first altitude measurement to obtain a first altitude;
at a second time:
perform, using the first sensor, a second ranging measurement with the second device to obtain a second distance; and
perform, using the second sensor, a second altitude measurement to obtain a second altitude;
determine a ranging difference between the first distance and the second distance; and
determine an altitude difference between the first altitude and the second altitude.

9. The computing device of claim 8, further comprising operations to:
determine whether the second device is on a different floor of a building than the computing device.

10. The computing device of claim 9, further comprising operations to:
display a notification on a display of the computing device, the notification indicating that the second device is on the different floor of the building than the computing device.

11. The computing device of claim 9, wherein determining whether the second device is on the different floor comprises operations to:
compare the altitude difference to a threshold; and
determine that the second device is on a different floor of the building in response to the altitude difference exceeding the threshold.

12. The computing device of claim 9, wherein determining whether the second device is on the different floor comprises operations to:
compare the ranging difference to a threshold; and
determine that the second device is on a different floor of the building in response to the ranging difference exceeding the threshold.

13. The computing device of claim 8, wherein determining the first altitude measurement comprises operations to:
perform a first air pressure measurement using the second sensor; and
calculate the first altitude measurement based on the first air pressure measurement.

14. The computing device of claim 13, wherein determining the altitude difference comprises operations to:
subtract a second air pressure reading corresponding to the second altitude measurement from the first air pressure measurement to calculate the altitude difference.

15. A computer-readable medium storing a plurality of instructions that, when executed by one or more processors of a computing device, cause the one or more processors to perform operations to:
at a first time:
perform, using a first sensor, a first ranging measurement with a second device to obtain a first distance; and
perform, using a second sensor, a first altitude measurement to obtain a first altitude;
at a second time:
perform, using the first sensor, a second ranging measurement with the second device to obtain a second distance; and
perform, using the second sensor, a second altitude measurement to obtain a second altitude;
determine a ranging difference between the first distance and the second distance; and
determine an altitude difference between the first altitude and the second altitude.

16. The computer-readable medium of claim 15, further comprising operations to:
determine whether the second device is on a different floor of a building than the computing device.

17. The computer-readable medium of claim 16, further comprising operations to:
display a notification on a display of the computing device, the notification indicating that the second device is on the different floor of the building than the computing device.

18. The computing device of claim 16, wherein determining whether the second device is on the different floor comprises operations to:
compare the altitude difference to a threshold; and
determine that the second device is on a different floor of the building in response to the altitude difference exceeding the threshold.

19. The computer-readable medium of claim 16, wherein determining whether the second device is on the different floor comprises operations to:
compare the ranging difference to a threshold; and
determine that the second device is on a different floor of the building in response to the ranging difference exceeding the threshold.

20. The computer-readable medium of claim 15, wherein determining the first altitude measurement comprises operations to:
perform a first air pressure measurement using the second sensor; and
calculate the first altitude measurement based on the first air pressure measurement.
